(19) United States
(12) Patent Application Publication
(10) Pub. No.: US 2025/0052887 A1
(43) Pub. Date: Feb. 13, 2025

(54) SYSTEMS AND METHODS FOR IMPLEMENTING A MULTISTATIC RADAR NETWORK FOR DETECTION OF AIRBORNE OBJECTS

(71) Applicant: AURA Network Systems, Inc., McLean, VA (US)

(72) Inventors: Michael Robert GAGNE, Monrovia, MD (US); William TOLPEGIN, McLean, VA (US); Tamara Lynne CASEY, Annapolis, MD (US)

(21) Appl. No.: 18/666,762

(22) Filed: May 16, 2024

Related U.S. Application Data
(60) Provisional application No. 63/502,574, filed on May 16, 2023.

(51) Int. Cl. G01S 13/72; G01S 13/00

(52) U.S. Cl. CPC G01S 13/723; G01S 13/003

(57) ABSTRACT

Disclosed herein are systems and methods for a multistatic radar system that is configured to detect airborne objects without the need for a transponder on the aircraft. The multistatic radar can be implemented using preexisting communications infrastructure associated with various networks such as paging networks. The multistatic radar system can be implemented using a plurality of multistatic communications links (e.g., transmitters that are communicatively coupled to a plurality of receivers). The distribution of transmitters and receivers in the network can be based on the RF conditions of the coverage area of the network. The multistatic radar network can produce one or more deterministic waveforms that provide the network with signal diversity needed for accurate detection, localization, and tracking of airborne assets. By controlling the waveforms in the system, as well as the density of the network, the multistatic radar system is able to use narrowband signals and operate with lower power than conventional radar systems.

### CROSS-REFERENCE TO RELATED APPLICATIONS

This application claims the benefit of U.S. Provisional Application 63/502,574, filed May 16, 2023, the content of which is herein incorporated by reference in its entirety for all purposes.

### FIELD

The present disclosure relates generally to systems and methods for detecting the presence of and the track of airborne objects such as unmanned airborne vehicles (UAVs) and other cooperative and non-cooperative airborne objects in a variety of types of airspace.

### BACKGROUND

Conventional radar systems that are currently being used to detect manned aircraft often are not adequate to detect UAVs and other airborne objects. Often times, radar systems that are used to detect manned aircraft are designed to work in conjunction with a transponder that is installed on the aircraft. When interrogated by the radar, the transponder can transmit a coded signal back to the radar, providing its position as well as other pertinent information about the aircraft's identity. Additionally, conventional radar used to detect and track manned aircraft may not be suited for small UAVs. Crewed aircraft (i.e., commercial, military, and passenger aircraft) are larger in size than UAVs, and conventional radar systems have been developed to be optimized for detecting larger airborne objects. Often times employing conventional radar systems to detect and track small UAVs leads to unacceptable results in which the UAV may not be detected with sufficient accuracy, or the path of travel (i.e., track) of the UAV is inaccurately portrayed. Often times, conventional radars while detecting a small UAV, may not be able to distinguish the UAV from other small airborne objects such as birds, and thus the conventional radar system may choose to ignore a detected UAV believing that the UAV is a bird or other small airborne object not worth tracking.

Increasing the sensitivity of conventional radar systems so that they are able to detect aircraft operating without a transponder or UAVs may not be a suitable solution. The sensitivity of conventional radar systems (i.e., the thresholds used by the system to distinguish legitimate signal from illegitimate signals) allow for radar systems to not only differentiate objects such as planes from small objects such as birds, but they also allow for the systems to differentiate between legitimate targets and multipath signals. By simply increasing the sensitivity, a radar system may generate an increased number of false positives (i.e., detecting objects when no objects actually exist) often mistaking a multipath signal for a legitimate signal.

### SUMMARY

Disclosed herein are systems and methods for a multistatic radar system that is configured to detect both crewed and uncrewed aircraft in a given airspace without the need for a transponder on the aircraft (e.g., uncooperative aircraft, or aircraft that are otherwise unable to or unwilling to provide location information directly to a network). In one or more examples, a multistatic radar network can be configured to include a plurality of radar “nodes” that can be implemented using both monostatic, bistatic, and/or multistatic (e.g., multiple receivers to a single transmitter) radar nodes that are placed in multiple locations that are spatially apart from one another. In one or more examples, the radar nodes can be placed strategically throughout an airspace to handle a variety of airspace surveillance requirements (e.g., dense urban environments, rural areas) to detect smaller UAVs, in and around infrastructure such as airports, and in areas historically unoccupied by crewed aircraft. For instance, in some examples, the density of receivers and transmitters in a given location can be strategically distributed based on RF conditions of a given coverage area and/or portion of a coverage area.

In one or more examples, each of the nodes of the system can be centrally controlled, and each of the radar nodes can be synchronized using GPS signals (as an example, but other methods can also be used, such as network based timing sources, external clocks, etc.) to improve the performance of the radar system. In one or more examples, the transmitters of the radar network can be synchronized such that they each emit a transmit signal simultaneously. In one or more examples, the transmit signals can not only be transmitted simultaneously from each transmitter in network, but the transmit signals can also be sent at the same frequency and/or using the same modulation scheme. Additionally or alternatively, the transmitters can be configured to implement a multifrequency configuration such that one set of nodes in the radar system transmit and receive at a first frequency, while other nodes in the radar system operate at second, third, or more frequencies such that the overall resolution of the radar network is increased due to increased diversity of signals which gives the radar network multiple different views of the same airborne target. In one or more examples, the transmitters can be operated in a round-robin scheme (described in detail below) that can be used to enable blanking of receivers to further reduce the interference received by the multistatic radar network. The multistatic radar network described above can implemented using preexisting communications infrastructure associated with various single frequency networks such as paging networks, FM radio networks, and Digital Video Broadcasting (DVB) Networks.

In some embodiments, the multistatic radar network described herein utilizes deterministic signals that are specifically configured to provide the network with a variety of viewpoints of targets to improve the overall accuracy of detection, localization, and tracking. For instance, the stand-alone multistatic network can transmit signals that are the same in multiple respects (e.g., frequency, time, and/or modulation) while also different in other aspects to provide signal diversity to the system, thereby facilitating accurate receiver signal fusion thus improving overall accuracy. In one or more examples, the bandwidth of a transmit signal (i.e., a signal emitted by the transmitters of the radar nodes in the multistatic network) can be 50 KHz nominally but can operate using a bandwidth of 50 KHz-125 KHz. This “narrowband” signal can stand in contrast to conventional systems or passive radar systems that use 200 KHz bandwidth signals such as those used in FM radio broadcasts as the illuminator. As demonstrated by the examples herein, by controlling the waveform as well as the density (e.g., distribution of transmitters and receivers in the network), the overall radar network is able to utilize narrow-band and low power signals to achieve accurate detection, location, and/or tracking of airborne assets.

In some embodiments, and in order to facilitate accurate sensor fusion, the multistatic radar system described herein can utilize a one or more methods for synchronizing the transmissions of signals. For instance, in one or more examples, the system can utilize an external timing system such as GPS or other shared clock to synchronize transmissions in the network to provide better accuracy of detection, localization, and/or tracking. Additionally or alternatively, the system can incorporate other methods to synchronize transmissions such as the use of a dedicated timing infrastructure that utilizes two-way time transfer and ranging (TTWTR) to synchronize the operations of the transmitters in the network. Additionally and/or alternatively, the system can utilize a single frequency network adapter as an alternative means to synchronize the timing of transmissions from the receivers in the multistatic network.

By allowing for the control of waveforms and timing, the multistatic radar networks described herein can overcome challenges associated with conventional radar systems that require large bandwidths, expensive antennas, higher transmit power, all while not requiring the aircraft in the network to include dedicated hardware (i.e., ADS-B) to share location data with the network.

### BRIEF DESCRIPTION OF THE FIGURES

The patent or application file contains at least one drawing executed in color. Copies of this patent or patent application publication with color drawings will be provided by the U.S. Patent and Trademark Office upon request and payment of the necessary fee. The invention will now be described, by way of example only, with reference to the accompanying drawings, in which:

FIG. 1 illustrates an exemplary multistatic radar network implemented with monostatic radar nodes according to examples of the disclosure.

FIG. 2 illustrates an exemplary multistatic radar network implemented with both monostatic and bistatic radar nodes according to examples of the disclosure.

FIG. 3 illustrates an exemplary multistatic and multifrequency radar network implemented with monostatic radar nodes according to examples of the disclosure.

FIG. 4A illustrates an exemplary multistatic radar network implemented with monostatic radar nodes and centrally controlled by a Single Frequency Network Adapter/processor according to examples of the disclosure.

FIG. 4B illustrates an exemplary set of reference signals according to example of the disclosure.

FIG. 5 illustrates an exemplary multistatic radar network implemented with both monostatic and bistatic radar nodes and centrally controlled by a Single Frequency Network Adapter/processor according to examples of the disclosure.

FIG. 6 illustrates an exemplary multistatic and multifrequency radar network implemented with monostatic radar nodes and centrally controlled by a Single Frequency Network Adapter/processor according to examples of the disclosure.

FIG. 7 illustrates an exemplary multistatic radar network composed of multiple single frequency networks according examples of the disclosure.

FIG. 8 illustrates an exemplary control system for a multistatic radar network according to examples of the disclosure.

FIG. 9 illustrates an exemplary process for operating a multistatic radar network to detect airborne objects according to examples of the disclosure.

FIG. 10 illustrates an exemplary dedicated timing network for a multistatic radar network according to example of the disclosure.

FIG. 11 illustrates an exemplary computing system, according to examples of the disclosure.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Described herein are systems and methods for detecting the position of aircraft or other airborne objects using a multistatic radar network system. In one or more examples, the radar network system can be configured to detect not only large airborne objects such as manned aircraft but can also be configured to detect smaller UAVs. In one or more examples, the radar network can be implemented as a multistatic radar network in which multiple radar nodes are interspersed throughout a large geographic area and collectively transmit signals and receive signals in order to locate and track airborne objects transiting the coverage area of the radar network. Optionally, instead of being operated as a stand-alone network, a preexisting single frequency network (such as a paging network) can be utilized as a radar network. In some examples, the radar network can incorporate one or more different timing methods to synchronize the transmission of signals in the radar including but not limited to using external clocks such as GPS signals, a dedicated timing network to synchronize the transmissions, and/or a centralized single frequency network adapter to synchronize transmissions.

In one or more examples, the multistatic radar network described throughout the examples described below can be implemented using at least in part a preexisting single frequency network such as a paging network, FM radio network, DVB network, etc., as an illuminator. Additionally and/or alternatively, the multi-static radar network can be implemented and operated as a stand-alone radar network that is configured with a plurality of transmitters and receivers to carry out position, velocity, and timing functionality.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, solid state drives, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Crewed (i.e., “manned” aircraft (i.e., commercial, cargo, private, and military aircraft) have been tracked by radar systems for many decades. The radar systems employed to track manned aircraft have been optimized to the size and speed of conventional aircraft in order to ensure accurate and reliable identification of the aircraft, and to track aircraft transiting a given coverage area of the radar system. For instance, in one or more examples, a sensitivity of the radar has been optimized such that the system can detect the aircraft while minimizing false positives (i.e., determining in error that an aircraft is present, when no aircraft is actually present).

Unmanned aircraft (i.e., UAVs) present a challenge to traditional active radar systems. Present UAVs tend to be smaller in size and more maneuverable, meaning UAVs are hard to not only detect using conventional radar, but are also more difficult to track (i.e., track the path of movement of the aircraft and its velocity in the event that the aircraft is moving and not hovering. The sensitivity of conventional radar systems can be increased such that they can be utilized to detect smaller UAVs, however, doing so would also increase the rate of false positives, thereby lowering the accuracy of the entire system. Additionally, conventional radar networks often require that aircraft operating within the network be equipped with a transponder in order to correlate detection of an object using the radar to an aircraft flying in the coverage area of the radar.

In one or more examples, a multistatic radar network can be employed to detect and track UAVs. As described in further detail below, a multistatic radar network can include a plurality of “radar nodes” (i.e., spatially diverse monostatic and/or bistatic radars) that can collectively determine the location, elevation, speed, and/or track of a UAV transiting the coverage area of the radar network. In one or more examples, the data collected from each of the radar nodes in the network can be “fused” together from multiple receivers and processed to determine, with improved accuracy, the location, elevation, velocity, and/or track of a UAV. By dispersing many radar nodes throughout the coverage area of the system, it becomes more likely that a target aircraft will be physically closer to at least one radar node, and thus will have a sufficient signal reflection to make detection and tracking more feasible. As will be discussed in further detail below, synchronizing the transmitters of the radar network so that they transmit a signal at the same time leads to an increase in performance of the system to allow for the detection and tracking of smaller UAVs. Furthermore, the multistatic radar network can be configured to transmit a diverse set of signals by selecting the carrier frequency and modulation scheme transmitted across the network thereby improving accuracy of the radar especially in areas that experience increased interference and/or channel fading.

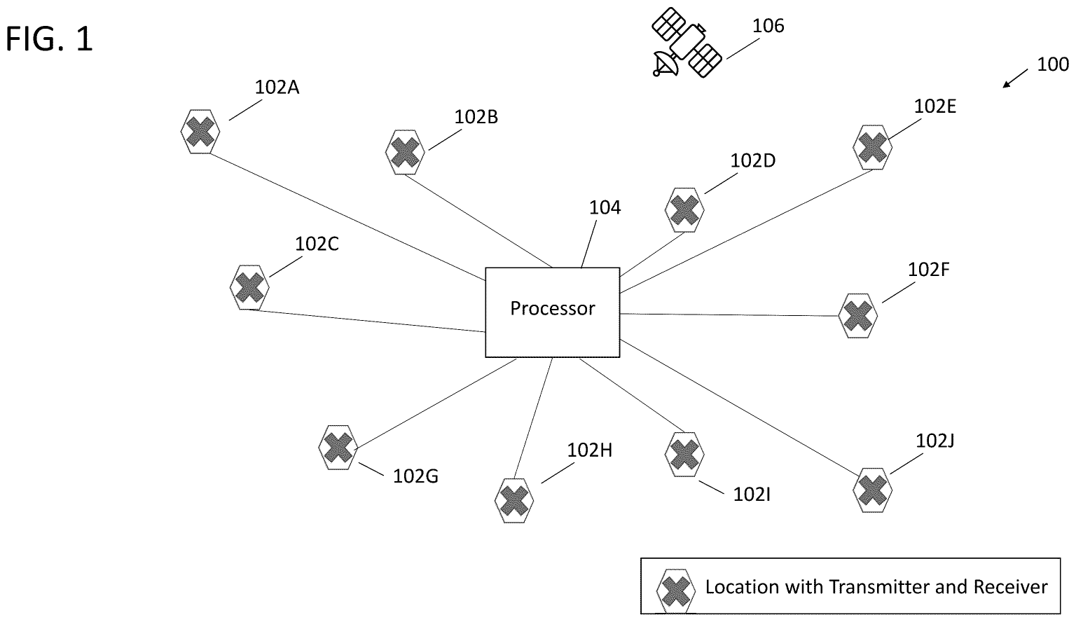

FIG. 1 illustrates an exemplary multistatic radar network implemented with monostatic radar nodes according to examples of the disclosure. In one or more examples, the system 100 of FIG. 1 illustrates an exemplary monostatic radar network that is configured to detect and track UAVs and other smaller airborne traffic. In some examples, the system 100 of FIG. 1 can be used to perform detection, localization, and tracking of airborne objects. Additionally and/or alternatively, the system 100 can be used in conjunction with a bistatic and/or multistatic system (described further below) to perform detection, localization, and/or tracking operations. In one or more examples, the system 100 can include a plurality of monostatic radar nodes 102A-J. While the examples of system 100 discloses ten separate radar nodes, the number of nodes shown should be seen as exemplary and not limiting to the disclosure. The term “monostatic” can refer to a radar node in which the receiver and transmitter of the radar node are co-located. A transmitter can refer to the portion of the radar node that emits an electromagnetic signal such as a pulse or other modulated waveform. A receiver can refer to the portion of the radar node that receives reflections from signals that are transmitted by the transmitter and reflected off airborne objects traversing the coverage area of the radar system. In the example of system 100 of FIG. 1, since each radar node is implemented as a monostatic radar node, both the transmitter and the receiver are co-located. In one or more examples, each of the transmitters of each radar node 102A-J can transmit an electromagnetic signal in the airspace of the coverage area. That electromagnetic signal can then contact an airborne object and then reflect back towards the radar node when scattered by the object, wherein the reflected signal can be detected/received by the receiver at the radar node. In one or more examples, the receiver of a given radar node can also receive signals reflected from signals transmitted by other transmitters of other radar nodes. For instance, using the system 100 as an example, a signal transmitted from the transmitter of radar node 102A can be reflected off an airborne object and that reflection could be received by not only the receiver associated with radar node 102A, but can also be received by other receivers in the network 100 such as the receivers associated with radar node 102B and 102C.

In one or more examples, the transmitter and emitter of each radar node 102A-J can be synchronized in time. In this context, synchronized can refer to each transmitter and receiver of a given radar node sharing a common time reference such that the transmitter can know the precise time to transmit a pulse or electromagnetic signal, and the receiver can know at what time precisely that a transmitter emitted a signal. By knowing the time of transmission, and the time that a reflection was received, the system 100 can determine the location, speed, and/or track of a given target. In one or more examples, synchronization can be achieved by using one or more Global Positioning System (GPS) signals that can be transmitted by one or more GPS satellites 106 that are communicatively coupled to each of the radar nodes 102A-J. Additionally and/or alternatively, other sources can be used for timing information such as the system 100 itself (e.g., such that system 100 is self-synchronizing). In one or more examples, each radar node 102A-J can receive a common clock signal from a GPS satellite 106, thus ensuring that not only each radar node 102A-J is synchronized with itself (i.e., the transmitter and the receiver of the radar node are synchronized), but also ensuring that each radar node 102A-J of the system 100 are synchronized with each other. As will be discussed in detail further below, in one or more examples, each transmitter of the radar network can be communicatively coupled to a controller (referred to as a single frequency network adapter/processor) that can be configured to cause the transmitters of the network to transmit a signal synchronously.

By ensuring that each radar node is synchronized in time with one another, the system can coordinate transmitting signals from the transmitters of each node, such that each transmitter in the network can transmit a signal at the same time. Multistatic radar networks that include multiple transmitters that transmit independently or asynchronously with one another, often experience increased channel fading due to multipath propagation. In some examples of radar systems, the multipath propagation can manifest as “clutter” in the radar signal which can mask “true” targets, thereby preventing accurate target detection. In one or more examples, the radar networks described herein are configured to provide a plurality of simultaneous views of a single target from multiple bistatic links which can help to improve the overall probability of detection. In some examples, because the target returns (e.g., reflections of signals that have been reflected off a target airborne object), and clutter returns will have differing signal characteristics in each bistatic link of the radar network, the radar network is able to tell the difference between a target signal and a clutter return. Increased channel fading due to multipath propagation (e.g., clutter) can leave radars incapable or unreliable when detecting objects with small radar cross-sections such as UAVs. Multi-path signals can be mistaken for objects with small radar cross-sections (e.g., due to clutter). Thus, a radar system may not be able to reliably detect UAVs and other smaller airborne objects, because such a system may not be able to distinguish multi-path signals from legitimate UAV reflections. Radar systems used to detect larger aircraft can ignore multi-path signals because larger aircraft have radar cross-sections that are distinguishable from multi-path signals. Thus, when a multi-path signal is received by a radar system designed to detect and track large objects such as manned aircraft, those signals can simply be ignored. However, in a system that is used to detect and track UAVs or other small objects, ignoring signals that appear to be multi-path signals may cause the radar system to also ignore legitimate signals. In one or more examples, simultaneous views of a radar target from multiple bistatic links can improve the probability of detection due to the target returns and the clutter returns (e.g., multipath signals) having differing relationships in each bistatic link, due to the geometric diversity created by a multi-static radar network. Thus, in one or more examples, each of the radar nodes 102A-J can be configured so that the transmitters of each radar node transmit a signal simultaneously or near simultaneously. By transmitting the signals simultaneously from each of the transmitters, legitimate reflection signals can be more distinguishable from multi-path signals since the time period in which reflection signals will arrive at a receiver can be distinguished from the time of arrival of multi-path signals or direct path transmissions from the transmitter to the receiver (i.e., signals that have not been reflected off an airborne object). The adverse effects associated with channel fading in a multistatic radar network can be mitigated or otherwise minimized by using signal diversity to transmit the signal over multiple paths that experience independent fading and then combining the signals coherently at the receiving antenna. In some examples, signal diversity provides the system with more views of a target (e.g., airborne object) meaning that the system has more chances to detect the target in a single link (“view”). In some examples, the target will have a different Doppler shift in each transmitter/receiver pair, thus increasing the overall chance that the target is outside of the cutter for at least one transmitter/receiver pair. Diversity schemes can refer to using different transmit signals in a common radar network to perform object detection and tracking. In one or more examples signal diversity can be achieved using varied carrier frequencies and/or modulation schemes employed across the transmitters of the network to reduce fading effects. Using the example network 100, the transmitters of the network although synchronized to transmit the signals at substantially the same time, can also emit signals at different carrier frequencies (described in further detail below) as well as different modulation schemes such that the overall network utilizes a diverse mix of signals that can lead to overall improvements in accuracy.

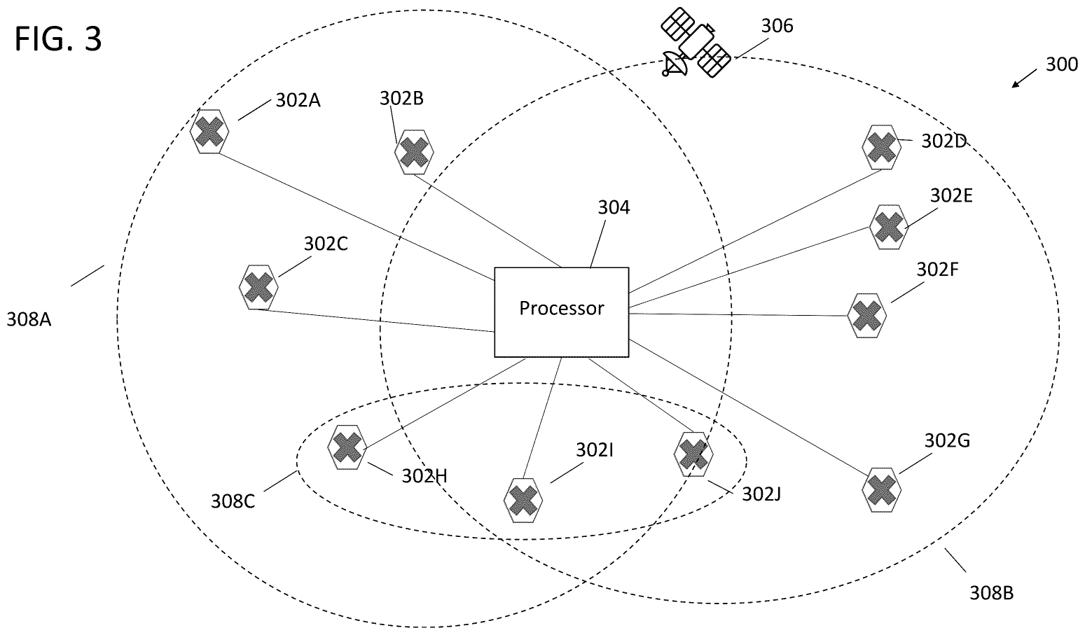

In one or more examples, a modulation scheme can refer to a process of varying one or more properties of a carrier waveform emitted at the transmitters to transmit information over the carrier waveform. Exemplary modulation schemes can include analog modulation schemes such as amplitude modulation (AM) and Frequency Modulation (FM), digital modulation such as Quadrature Amplitude Modulation (QAM), Time Division Multiple Access (TDMA), Doppler Division Multiple Access (DDMA), Binary Phase-shift keying (BPSK), etc. The list provided here is meant to be exemplary and should not be seen as limiting to the disclosure. In one or more examples, each transmitter or groups of transmitters in the multistatic radar network can transmit signals using its own distinct modulation scheme, thereby facilitating more accurate identification of the origins of a reflection signal at the receivers. Using the example system 100 as an example, each of the transmitters associated with radar nodes 102A-J can each use its own distinct (orthogonal) modulation scheme when transmitting signals. Alternatively, groups of transmitters, i.e., a first plurality of transmitters in the radar network can transmit using a first common modulation scheme, while a second plurality of transmitters (that are mutually exclusive of the first plurality) can transmit a different (orthogonal) second common modulation scheme. By increasing the diversity of the signals used to detect and track airborne objects, along with fusing the data, the overall accuracy of the radar network can be improved. This improvement can be substantial in RF environments that have increased channel fading (due to multipath) or other conditions that can degrade radar performance. In one or more examples, the geometric diversity of the transmitters and receivers (e.g., the way in which the transmitters and receivers are distributed through the coverage area) provides the radar network with geometrically diverse views of an airborne object, which can improve detection sensitivity and localization accuracy. As described above, the transmits signals can be orthogonal (or near orthogonal) so that they can be distinguishable at each receiver. Signals can be made orthogonal using by choice of carrier frequencies, varying modulation schemes, and/or varying timing sequences. As will be described in further detail below (with respect to FIG. 3) in addition to selecting the modulation schemes used across the transmitters, the radar network can also utilize multiple carrier frequencies throughout the network as another variable to further increase signal diversity across the radar network.

In one or more examples, each of the radar nodes 102A-J can be communicatively coupled to a common processor 104. In one or more examples, the processor 104 can be configured to receive position data for each radar node transmitter and reflection signals from each of the radar nodes 102A-J and can process the received signals to determine the location, speed, and/or track of an airborne object transiting the airspace covered by the coverage area of the network. In one or more examples, the processor 104 can receive reflection signals from each of the radar nodes 102A-J and “fuse” the received data together with transmitter and/or receiver position data to determine the location, elevation, velocity, and/or track of objects transiting the airspace of the coverage area of the network. In one or examples, “fusing” the data together can include knowing an angle of transmit and determining an angle of arrival for each received signal. By calculating angle of arrival for each received signal, the location of the airborne object can be triangulated and/or multilateraled (e.g., fusing ranging measurements from multiple nodes) to determine the precise location, elevation, velocity, and/or track of the aircraft. In one or more examples, the angle of transmit can refer to the angle between the transmitter and the object receiving the transmitted signal. In one or more examples, the angle of reflection can refer to the angle between the object and the receiver that received the reflection signal.

In one or more examples, the location of each of the radar nodes 102A-J, and the configuration of (specifically the distances between) the individual nodes, can be based on the desired performance of the radar network and based on the desired coverage area of the radar network. In one or more examples, the configuration of the network (i.e., the placement of the radar nodes in the network) can be based on known (pre-planned) flight routes so as to improve flight-based object awareness. Additionally, or alternatively, the placement of the radar nodes in the network can be based on known infrastructure site locations such as airports, heliports, vertiports, known flight routes (i.e., SIDs, STARs, Victor Airways, VFR Flight corridors), and other known types of infrastructure. In other words, by placing the radar nodes such that the coverage area covers known flight routes, the likelihood of detecting aircraft (rather than false positives such as birds) can be minimized.

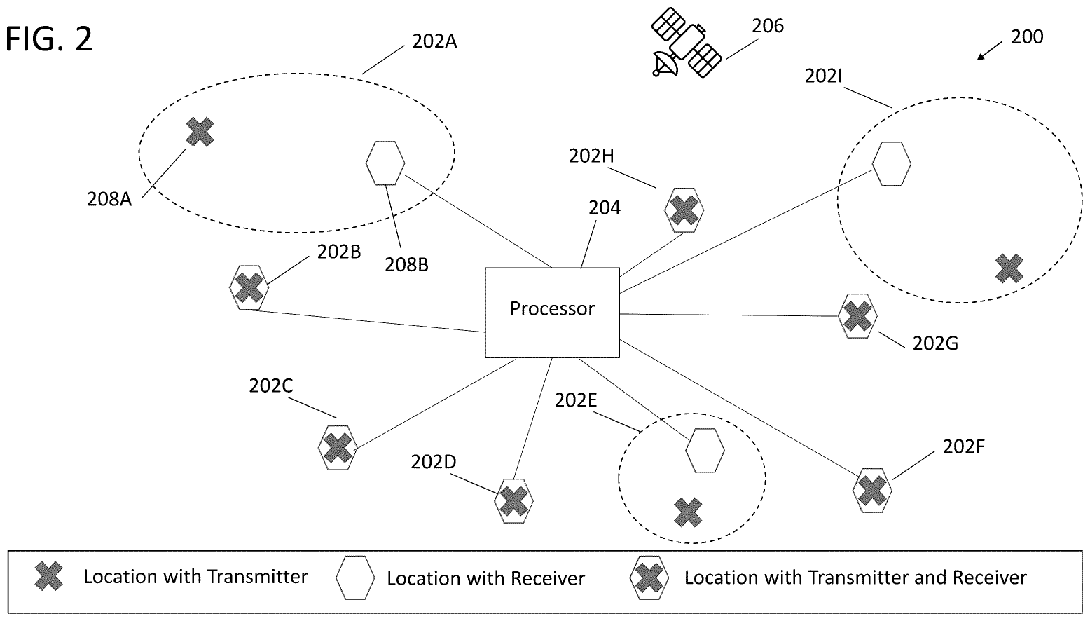

FIG. 2 illustrates an exemplary multistatic radar network implemented with both monostatic and bistatic radar nodes according to examples of the disclosure. In one or more examples, the system 200 of FIG. 2 can be substantially the same as system 100 of FIG. 1, however, in the example of system 200, at least one or more of the radar nodes 202 are implemented as bistatic radar nodes rather that monostatic radar nodes. A bistatic radar node can refer to a radar node in the network of radars in which the transmitter and receiver are geographically separated from one another. Using the example of system 200 of FIG. 2, the system 200 can include a plurality of radar nodes 202A-I similar to the example system 100 of FIG. 2. However, while system 100 is depicted as being made up entirely of monostatic radar nodes, the system of FIG. 2 is implemented with a mixture of both monostatic, bistatic radar, and/or multistatic radar nodes (in which multiple receivers are in communication with a common transmitter). For instance, radar node 202A, include a transmitter 208A and a receiver 208B that are geographically separated from one another. In one or more examples of the disclosure, the geographic distance and relative position of the transmitter 208A and receiver 208B can be pre-configured based on the desired performance of the radar system

In one or more examples, the system 200 can include both bistatic radar nodes (i.e., radar nodes 202A, 202E, and 202I) as well as monostatic radar nodes (i.e., radar nodes 202B, 202C, 202D, 202F, and 202G). While the example system 200 includes a mixture of both monostatic and bistatic radar nodes, in one or more examples, a system such as system 200 depicted in FIG. 2 can comprise only bistatic radar nodes or can comprise only monostatic radar nodes (such as the example system 100 of FIG. 1).

In one or more examples, the transmitters and receivers of the system 200 can be synchronized using a GPS signal (emitted by satellite 206) or other means similar to the example system 100 of FIG. 1. Thus, in one or more examples, each of the transmitters in the network (whether they are part of a monostatic radar node or a bistatic radar node) can simultaneously or (at least near simultaneously) transmit a signal. In one or more examples, since each of the transmitter and receiver locations are known and fixed, a determination can be made as to the location, elevation, velocity, and/or track of a target based on the reflected signals received by each of the receivers in the network as well as the locations and elevations of each of the transmitters and receivers in the network. In one or more examples, and in some circumstances, by implementing at least one or more of the radar nodes as bistatic radar nodes, the overall performance of the radar network can be increased.

In one or more examples, and similar to the example system 100 of FIG. 1, the plurality of radar nodes 202A-I and in particular the transmitters of each radar node can be configured such that the overall radar network transmits a diverse signal set, including but not limited to transmitting signals using different modulation schemes, carrier frequencies, and/or timing sequences as described above with respect to FIG. 1. Thus, similar to the example of FIG. 1, the system 200 of FIG. 2 and in particular the transmit elements of the system 200 can transmit signals synchronously using a variety of modulation schemes so as to minimize channel fading on the radar network (by providing the multistatic radar network with signal diversity) thereby improving the overall accuracy of the system. In one or more examples, the simultaneous transmission from multiple bistatic radar links can provide simultaneous views of a particular target (e.g., an airborne vehicle) from geometrically diverse viewpoints. Each view point can have different signal/clutter relationships, which the system can user to differentiate target signals from clutter. Each view can provide different spatial information about the target that can be “fused” together to determine the target's position and velocity. In one or more examples, the number of different modulation schemes used by the transmitters at any given time, as well as the location of the transmitters can be based on the characteristics of the RF environment in which the radar network is operating. For instance, in an area where channel fading may be increased due to multipath, the transmitters of the radar network that are proximal to such area can be operated such that each transmitter or one or more groups of transmitters transmit a different modulation scheme (which are orthogonal and/or nearly orthogonal to one another so that they different signals can be separated and processed independent at each receiver), thereby providing increased signal diversity in at least the area of increased channel fading. As will be discussed in further detail below, in addition to modulation scheme, the system can also employ different carrier frequencies to further increase signal diversity, thereby providing improved performance especially in areas where channel fading is of greater concern (i.e., an urban area, airport, etc.)

In one or more examples, the system 200 can include a processor 204 that can be communicatively coupled to each of the receivers of the network in order to make location, elevation, speed, and/or track determinations of objects transiting the airspace based on reflection signals received from each of the receivers as described above with respect to processor 104 of system 100. In one or more examples, the processor 204 can also be communicatively coupled to each of the transmitters of each radar node to operate the transmitters such that they emit signals that are coordinated to improve signal diversity of the multistatic radar network. Additionally or alternatively, the transmitters can be configured to emit the same signal at the same time without being directed to do so by the processor 204. For instance, each of the transmitters of each radar node 202A-I can use the GPS signals received from satellite 206, to synchronize their time reference (i.e., their clock signals) and can be configured to emit a signal at the same time based on the shared time reference. In one or more examples, the transmitters in a monostatic implementation can also be configured to emit a signal based on the GPS signal, without requiring any intervention from the processor.

In the example systems 100 and 200 of FIGS. 1 and 2 respectively, the transmitters can emit a choice of signals (i.e., using different orthogonal waveforms) at the same time using the same frequency. As described in detail below, a multistatic radar network that employs multiple frequencies (i.e., a multifrequency system) can be operated in substantially the same way as the examples provided above with respect to FIGS. 1-2, except the transmitters can transmit at different carrier frequencies to further increase the signal diversity of the radar network in various coverage areas based on the needs of the network.

FIG. 3 illustrates an exemplary multistatic and multifrequency radar network implemented with monostatic, bistatic, and/or multistatic radar nodes according to examples of the disclosure. In one or more examples, the system 300 depicted in FIG. 3 can operate in substantially the same manner as the system 100 depicted in FIG. 1. Thus, the radar nodes 302A-J, the processor 304, and satellite 306 can operate in substantially the same manner as their counterparts 102A-J, 104, and 106 respectively described above with respect to FIG. 1. However, in one or more examples, rather than transmit a signal at the same time and/or same carrier frequency, in one or more examples, a subset of the radar nodes can operate at a first frequency, a subset of the radar nodes can operate a second frequency, and a subset can operate at a third frequency, thus allowing the entirety of the network 300 to operate in a multifrequency configuration providing frequency diversity (e.g., signal diversity). For instance, using the example system 300 of FIG. 3, radar nodes 302A-302C can collectively operate in a first frequency zone 308A, radar nodes 302D-G can operate in a second frequency zone 308B, and radar nodes 302H-J can operate as a third frequency zone 308C. Optionally, any of the transmitters in the system 300 can operate at multiple frequencies by changing its carrier frequency on a time-basis or transmitting multiple frequencies simultaneously. In one or more examples, and as discussed in further detail below, the “frequency zones” can have overlapping coverage areas, meaning that a receiver associated with a transmitter can not only receive signals from the transmitters that are in the same frequency zone as the radar node (thus providing greater signal diversity), but also signals from other transmitters associated with other frequency zones. In this way, and as discussed below, the amount of signal diversity at a given location in the coverage area of the radar network can be increased or decreased based on factors such as the channel fading experienced at the location. In one or more examples, in addition to diversity of the carrier frequencies as discussed in further detail below, the transmitters of the system 300 can also be configured to operate using a variety of modulation schemes similar to the examples described above with respect to FIGS. 1-2. Thus, in one or more examples, the system 300 of FIG. 3 can be implemented as a multistatic radar network that utilizes a plurality of transmitters, with each transmitter transmitting at a specific modulation scheme and at a specific carrier frequency, such that the signals generated across the network are diverse (from a modulation scheme and frequency perspective) thereby improving the performance of the multistatic radar network overall.

In one or more examples, the radar nodes associated with a frequency zone can transmit signals at the same time and at the same frequency, while the radar nodes of each distinct frequency zone can operate at different frequencies. For instance, radar nodes 302A-C operating in frequency zone 308A can all transmit signals at a first frequency, radar nodes 302D-G operating in frequency zone 308B can operate at a second frequency, while radar nodes 302H-J can operate at third frequency, wherein the first, second, and third frequencies are distinct from one another. In one or more examples, by employing multiple frequencies, the system 300 can improve the overall resolution of the radar network within a region in which the transmitted signals overlap. In one or more examples, each of the receivers associated with each of the radar nodes 302A-J can be configured to receive all three frequencies, while the transmitters associated with each radar node can be configured to transmit signals at the frequency associated with the frequency zone it is associated with. Diversifying the frequencies used by the transmitters, can allow for the processor 304 to identify the transmitter or transmitters associated with the reflection signals received at the processor 304 thereby allowing for increased accuracy in detection and tracking of airborne object transiting the coverage area of the network. In one or more examples, by employing multiple frequencies across the network 300, the frequency assignments and/or the modulation schemes given to each radar node can be customized to improve resolution and provide the system with redundancy (i.e., if a particular frequency is experiencing significant interference, then the system can still operate using the other frequencies of the system). Additionally, the use of multiple frequencies can allow for the transmit power at each radar node to customized by frequency as needed.

In one or more examples, the overlap of the frequencies can be configured such that an area that may experience significant channel fading (i.e., an urban area, airport, etc) can have multiple frequency zones overlap to provide increased signal diversity at the area. In one or more examples, the density of receivers in a congested area can be increased to improve signal diversity. Thus, in one or more examples, and using the system 300 as an example, frequency zones 308A-C can be configured such that their coverage areas all overlap in a region of the coverage area of the radar network that experiences increased channel fading or other conditions in which performance of the radar may be degraded. For instance, the coverage area around radar node 302I can include transmissions from all frequency zones 308A-C thereby providing the area with increased signal diversity. In contrast, the coverage area in the proximity of radar node 302A may only be within the coverage area of a single frequency zone (308A).

In the examples of FIGS. 1-3, the transmitters of each radar node can employ a GPS signal or other means to synchronize their internal clocks so that they transmit a signal at substantially the same time or in some synchronized/coordinated manner. In the example of FIGS. 1-3, each of the transmitters of each radar node can be independently operated but transmit at the same time because they use a common clock/time reference. By transmitting the same signal at substantially the same time (but not necessarily at the same time), the transmitters of the systems of FIGS. 1-3 effectively operate as a single frequency network. In one or more examples, a single frequency network can refer to a network of transmitters (i.e., digital broadcast network) wherein the transmitters send the same signal and/or the same frequency channel at approximately the same time. In the examples of FIGS. 1-3, each of the radar nodes are operated independently insofar as they each transmit signals without external control. In such a scenario, synchronicity is maintained due to a common clock derived from a commonly received GPS signal or other means.

However, in one or more examples, rather than depend on a common clock reference to maintain synchronicity, the transmitters of the network can be commonly controlled such that they transmit the same signal at the same time. In one or more examples, a common controller such as a single frequency network adapter (described below in further detail) can be used to control a plurality of transmitters from a single source. By synchronizing the transmitters to a single point truth (i.e., a single frequency network adapter) the variation in timing between transmitters can be minimized. Furthermore, and as discussed in detail below, a single frequency network adapter can alongside a pre-existing communications infrastructure to also operate as a multistatic radar network similar to the examples described above with respect to FIGS. 1-3. In one or more examples, the conversion or “co-opting” of a pre-existing communications network to operate as a multistatic radar network can be implemented in a manner that still allows for the communications network to maintain its pre-existing use and mission, while also (and in some examples) continuously operating as multistatic radar network.

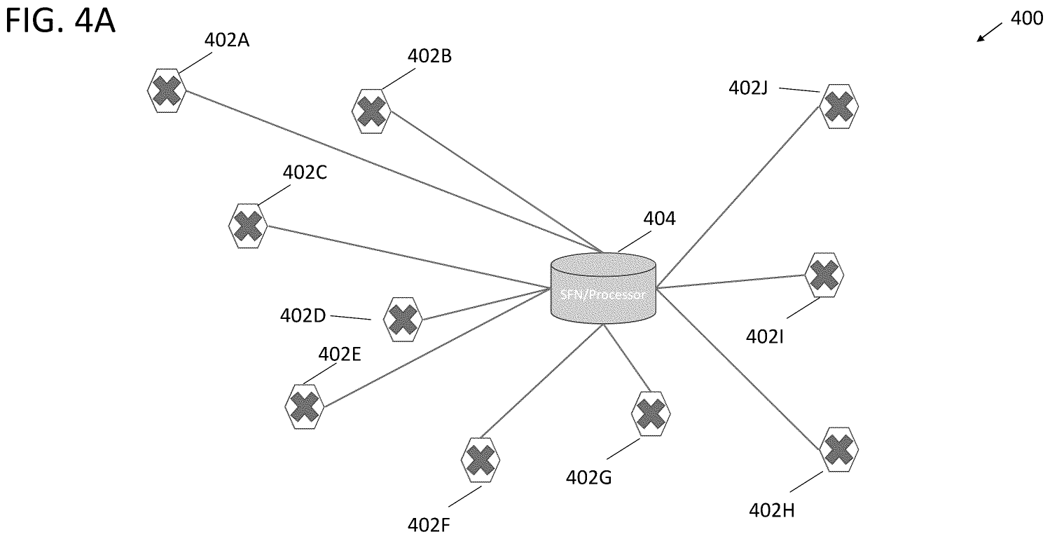

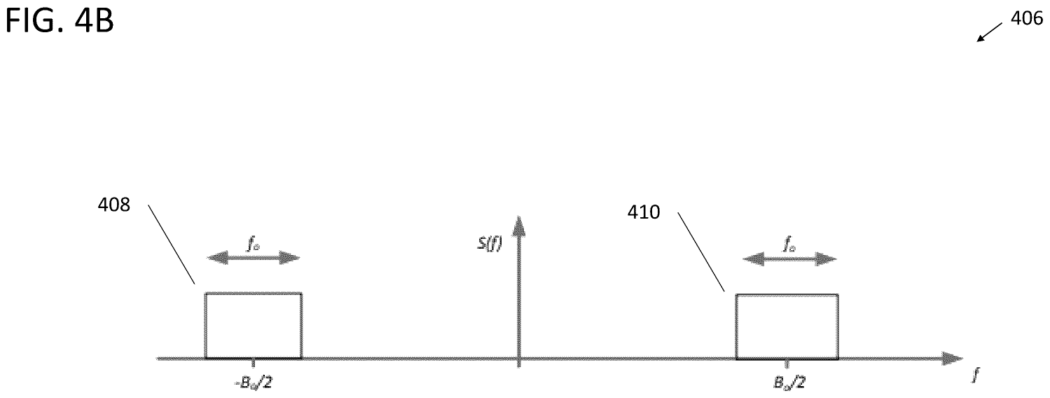

FIG. 4A illustrates an exemplary multistatic radar network implemented with monostatic radar nodes and centrally controlled by a Single Frequency Network Adapter according to examples of the disclosure. In one or more examples, the system 400 of FIG. 4A can be configured in substantially the same way as the system 100 described above with respect to FIG. 1. Thus, in one or more examples, the system 400 can include a plurality of radar nodes 402A-J that are implemented as monostatic radars in a manner similar to that described above with respect to system 100 of FIG. 1. However, in contrast to the example of system 100, the transmitters of each radar node can be centrally controlled by a dual Single Frequency Network (SFN) Adapter/processor 404 that can be communicatively coupled to each of the transmitters of the network 400. In some examples, the SFNA/processor performs the functionality of the processor described above with respect to FIGS. 1-3, and can also perform additional functionality including coordinating the timing of operations amongst the nodes in the network as described further herein. In one or more examples, the SFN Adapter/processor 404 can be configured to coordinate and operate each of the transmitters of the network so as to operate the network as a multi-static radar network. In one or more examples, the SFN Adapter/processor 404 operates each of the transmitters in the system 400 in a coordinated manner so as to provide the overall system with signal diversity that enables accurate detection of airborne objects. For instance, the SFN Adapter/processor coordinates the transmitters of the system 400 such that the transmitters transmit waveforms that are substantially identical in two of three categories: (1) modulation scheme, (2) time, and/or (3) carrier frequency. In one or more examples, the single frequency network adapter 404 can be centrally located with respect to the transmitters that it is communicatively coupled to and can be configured to send a common data stream to each transmitter, and specifically to a modulator located at each transmitter. In one or more examples, the SFN Adapter/processor 404 can calibrate the differences (such as distance) between the adapter and all of the transmitters to ensure that the common data stream is received at each transmitter at the same time, thereby ensuring that the transmitters transmit their signals at substantially the same time (i.e., synchronously).

In one or more examples, the SFN Adapter/processor 404 and the transmitters communicatively coupled to it can be implemented using a pre-existing single frequency network that has alternate primary uses. For instance, in one or more examples, the SFN Adapter/processor 404 and the transmitters can be implemented using a paging network system that while primarily used to implement a paging system (i.e., operate and communicate with pagers) can be also used to implement the transmitter portion of the multistatic radar network. In addition to paging networks, other types of known single frequency networks can be co-opted to serve as the transmitters for the multistatic radar network such as Digital Video Broadcast (DVB) networks. In one or more examples, by using a single frequency network that is centrally controlled by a SFN adapter, the synchronization between transmitters such that they can transmit a signal at the same time, can minimize channel fading thus improving the overall reliability of the system. In one or more examples, the time at which the signals transmitted by SFN Adapter/processor 404 to operate each transmitter arrives at the transmitters may vary due to the differing distances between the transmitters and the SFN Adapter/processor 404. Thus, in one or more examples, the system 400 can be implemented in dense coverage areas (i.e., such as urban/metropolitan cities) where multi-path propagation effects are more prevalent. In one or more examples, the system 400 can be combined with other radar systems that are each operated by their own respective single frequency network adapters to service a given coverage area. Thus, in one or more examples, a multistatic radar network that provides detection and tracking for a given coverage area, can be made up of multiple single frequency networks such as any of the networks described in the present disclosure and can even be combined with radar networks known in the art.

In one or more examples, a pre-existing paging network that is being utilized to implement a paging network can be used to implement the multistatic radar network with minimal modification. For instance, and as described above, the transmitters of the network can be made to be communicatively coupled to a single frequency network adapter (such as SFN Adapter/processor 404 described above) that can operate to ensure that the transmitters are synchronized such that they transmit signals in a coordinated fashion to provide the overall radar network with signal diversity to differentiate target signals from clutter signals thus utilizing the paging network (i.e., the single frequency network) as a multistatic radar network. The single frequency network adapter can additionally be configured to operate a multistatic radar network that uses multiple frequencies and multiple modulation schemes across the network (described above with respect to FIG. 3), ensuring that the transmitters in the network operating at a particular frequency are synchronized with one another, and/or ensuring that all of the transmitters regardless of the frequency they operate at, are synchronized to transmit signals at the same time and/or using orthogonal modulation schemes. The single frequency network adapter thus can be configured to convert a pre-existing paging network or other single frequency network into a multistatic radar network by ensuring that the transmitters of the paging network are operated in a manner that makes them suitable for multistatic radar detection and tracking. In one or more examples, and as discussed above, operating the paging network can include operating the transmitters to ensure that they are transmitting synchronously.

In one or more examples, and as described above, a preexisting single frequency network such as a paging network can be operated as a multistatic radar network while still retaining its original purpose/mission. Additionally and/or alternatively the multistatic radar network described herein can be implemented as a stand-alone radar network that doesn't serve any other purposes. In the example of a paging network, the transmitters of the paging network can be communicatively coupled to a single frequency network adapter so as to operate the paging network as both a paging network and a multistatic radar network. When the paging network has a page to send to a customer of the paging network, and using the example system 400 as an example, the SFN Adapter/processor 404 can cause the one more radar nodes 402A-J, in particular the transmitters of the radar nodes, to emit a signal synchronously using a signal that can be recognized by a paging network customer as a page. In one or more examples, and in keeping with its operation as a paging network, the signals transmitted by the transmitters when operating as a paging network can be the same frequency and utilize the same modulation scheme (so that a customer pager will be able to recognize that they have received a page). Nonetheless, even when the transmitters of the paging network are being utilized for their original purpose, the transmitted signals can still be used to facilitate detection and tracking of airborne objects. The transmitted signals, while having been transmitted synchronously using the same frequency and modulation scheme for paging purposes, can still represent an emitter of opportunity that can be reflected off airborne objects and received by the one or more receivers of the multistatic radar network to detect and track objects.

When the paging network is idle (i.e., the network is not attempting to transmit a page to a customer), then in one or more examples, the single frequency network adapter 404 can operate the one or more transmitters of the paging network in a “radar illuminator” mode by causing the one or more transmitters to synchronously (e.g., in time, frequency and/or modulation scheme) transmit a signal that can be used for detection and tracking purposes but may not be recognized by pagers on the network as a paging signal. In the “radar illuminator mode” the system 400 of FIG. 4A can have increased signal diversity since it is not constrained by having to operate a functional paging network. For instance, each transmitter of the paging network can emit a different signal synchronously, thereby generating a distinct signal at each transmitter. In addition, the transmitted signal may be chosen to be more applicable to the radar mode and that of the paging mode. In addition, the transmitted signal may be chosen to be more applicable to the radar mode and that of the paging mode. When the system 400 is operating in the paging mode, the system can still operate as a multistatic radar network (in addition to a paging network), albeit with decreased signal diversity.

In order to ensure that the system 400 can continuously operate as a multistatic radar network, even though the system 400 is switching back and forth between a “paging” mode and a “radar” mode, the system 400 can include one or more reference transmitters that continuously emit a common signal that does not change even though the system 400 may be changing modes as described above. Using, the system 400 as an example, in one or more examples, while the transmitters of radar nodes 402B-I can operate as both paging network transmitters and multistatic radar node transmitters, switching back and forth between modes as described above, the transmitters associated with radar nodes 402A and 402J can be reserved as reference transmitters for the purpose of ensuring that the multistatic radar network can operate continuously. In one or more examples, each reference transmitter can periodically transmit a signal using the same carrier frequency and modulation scheme each time. The reference transmitters may not transmit the same carrier frequency and modulation scheme as compared to one another, so long as each transmitter transmits a consistent signal with respect to itself. In one or more examples, the reference signals produced by the reference transmitters are chosen to more easily detect changes in location and speed of objects transiting the coverage area of the radar network, especially in examples where the other transmitters are going back and forth between paging and radar modes as described above. In one or more examples, the location and number of reference transmitters can be configured to maximize system performance of the multistatic radar network and can be based on a variety of factors including but not limited the RF environment of the coverage area of the radar network. In one or more examples, the reference signal can be emitted as part of the paging network as described above, as part of a stand-alone multistatic radar network as described above with respect to FIGS. 4 or can be implemented as a stand-alone network with its own dedicated single frequency network adapter (described in further detail below).

The reference signals described above can be specifically selected to not only improve the accuracy of the overall multistatic radar network but can also be configured to increase the range of the system without having to utilize higher powered transmitters at each radar node. In one or more examples, and as described in further detail below, the reference signals can be configured to collectively mimic a single high power (thereby improving range) wide-band signal (thereby improving accuracy.) FIG. 4B illustrates an exemplary set of reference signals according to example of the disclosure. In one or more examples, the set of reference signals 406 can be emitted from one or more transmitters of a multistatic radar network. The set of signals 406 can include two narrowband channels (each with a bandwidth of fₒ₎ separated by Bₒ (where Bₒ represents the frequency separation between the two signals). For Bₒ>>fₒ, the root-mean-square (rms) bandwidth of the signal is given by Bₒ/2. In the time domain, the signals 406 can be represented as a sinc function (i.e., sinx/x) of 3-dB time 1/fₒ repeated every 1/Bₒ. In one or more examples, if the channel bandwidth fₒ is 100 kHz and the frequency distance between channels Bₒ is 1.0 MHz, the time domain pulse width is 10 milliseconds, and the repeat time is 0.001 milliseconds. Accordingly, within every 3-dB pulse width there would be 10,000 copies of the sinx/x, each separated by 0.001 milliseconds. As fₒ becomes smaller relative to Bₒ the time domain approaches two CW signals who constructively and destructively interfere with a beat frequency of Bₒ and can be represented as a cosine function where f(Bₒ/2)=f(−Bₒ/2). In one or more examples, as fₒ approaches Bₒ, the pulse width and repeat time become identical thereby making the two separate signals appear as a single sinx/x in the time domain whose 3-dB pulse width is 1/Bₒ. Additional channels several MHz away (e.g. 10-MHZ) can be used to transmit the illuminating signals providing more frequency diversity.

Thus, as demonstrated above, a single wideband signal can be “spoofed” by using two separate narrowband signals that are configured to appear as a single wideband signal. A wideband signal being used in a multistatic radar network as an emitter that is reflected/scattered by airborne objects can improve the accuracy of radar network. However, in order to transmit a wideband signal from a single transmitter, may require the transmitter to be rated for higher power. By spoofing a wideband signal using two or more separate transmitters, a wideband signal can be created using lower power transmitters than what would be required if a single transmitter were transmitting the signal. Thus, in one or more examples, recreating a single wideband signal using two narrow band signals transmitted from separate transmitters can allow for realization of the performance enhancement associated with wideband signals, without requiring higher powered transmit antennas. In one or more examples, the waveform described above can be used in a system that employs a combination of waveforms (e.g., alternative waveforms on different frequencies) that can provide the system with a diversity of views thus improving the accuracy of the system.

While an existing paging network could be utilized with minimal modification to implement a multistatic network as described above, in one or more examples, the preexisting paging network and in particular the transmitting antennas of the network could be modified to improve the performance of the network to act as a multistatic radar network. For instance, when operating as a paging network, the antennas of the paging network located at each transmitter, may be configured to support terrestrial communications by having their beams (i.e., their direction of propagation) pointed laterally or towards the ground so as to support communicating with pagers that are located on the ground. However, when operating as radar transmitters for detecting airborne vehicular traffic, the orientation (tilt) of the beams can be modified so that the signals propagate towards the sky as well to increase the chance that the transmitted signals will reflect off of airborne objects directly without experiencing multipath propagation (i.e., reflecting off of objects on the ground before reaching an airborne object). In one or more examples, the antennas could be modified by changing the polarization of the signals being transmitted. Additionally and/or alternatively, the antennas can be modified to be both horizontally and vertically polarized so as to be optimized for both use cases. For instance, when operating as a paging network, the antennas may be configured to emit horizontally polarized signals. However, when operating as a multistatic radar network, the antennas can be modified to either additionally or alternatively emit vertically polarized signals, thereby reducing multipath signal that may degrade performance of the network when being operated as a multistatic radar network. In the case where the paging network utilizes phased array antennas, the elements of the antenna can be modified to ensure that the beam produced by the antenna is oriented to the sky for the purposed of reflecting off of airborne vehicular traffic. The above modifications are optional and are not required to operate an existing paging or other single frequency network as a multistatic radar network.

In one or more examples, the receivers of each radar node 402A-J can be communicatively coupled to a common processor (not pictured) that can process the received reflection signals to determine the location, elevation, speed, and/or track of objects transiting the airspace in the coverage area of the network similar to the example described above with respect to FIG. 1. In one or more examples, each of example systems describe above with respect to FIGS. 1-3 can be implemented as a system in which the transmitters are centrally controlled by a SFN adapter, such as SFN Adapter/processor 404 described above with respect to FIG. 4A. For instance, as described below, the SFN implementation of a multistatic radar network can be applied to bistatic radar nodes as well as multifrequency multistatic systems.

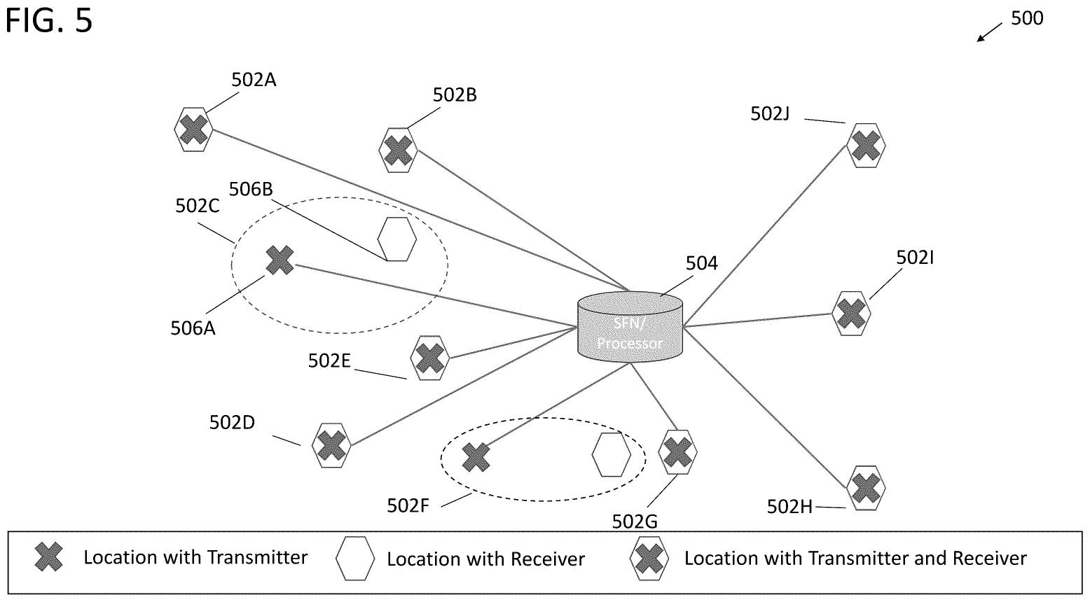

FIG. 5 illustrates an exemplary multistatic radar network implemented with both monostatic and bistatic radar nodes and centrally controlled by a Single Frequency Network Adapter according to examples of the disclosure. In one or more examples, the system 500 of FIG. 5 can operate in substantially the same manner as the system 200 of FIG. 2. Thus, in one or more examples, the system 500 includes a plurality of bistatic and monostatic radar nodes 502A-J, which collectively are used to detect and track airborne objects within a given coverage area. In one or more examples, the bistatic radar nodes (502C and 502F) can be configured in a similar manner to the bistatic nodes of system 200 described above. For instance, in one or more examples, bistatic radar node 502C (i.e., a radar node in which the transmitter and receiver are geographically separated) can include a transmitter 506A and a receiver 506B which are geographically separated. Similar to the example system 200 of FIG. 2, the receiver 506B can be communicatively coupled to a processor that can receive the reflection signals from each of the radar node transmitters in order to detect and track airborne objects by fusing the data received at each receiver to determine the location and/or velocity of an airborne object.

In one or more examples, the transmitters of each radar node (regardless as to whether it is part of a bistatic or monostatic radar node) can be communicatively coupled to SFN Adapter/processor 404. In one or more examples, SFN Adapter/processor 504 can be communicatively coupled to each of the transmitters in each radar node 502A-J and can be configured to command or cause each transmitter to emit a signal simultaneously. Similar to the example of FIG. 4A, the SFN Adapter/processor 404, by coordinating the transmission of signals for each of the transmitters of the network, can minimize channel fading and thereby make the radar system more reliable for detecting UAVs and other airborne objects with radar cross-sections that are smaller than a manned aircraft. Also similar to the example of FIG. 4A, the SFN Adapter/processor 404 as well as the transmitters of each radar node 502A-J can be co-opted from an existing single frequency network system such as paging network, so that the paging network provides the illuminators in the radar system, and the receivers send any received reflections to a central processor (not pictured) as discussed above.

In one or more examples, the concept of using a SFN adapter and a single frequency network system to implement the transmitters for a multistatic radar system, can also be applied to a multistatic and multifrequency system such as the one described above with respect to FIG. 3. In the case of a multifrequency radar system, the transmitters of the system can be operated such that they emit the same signal at the same time but at different carrier frequencies.

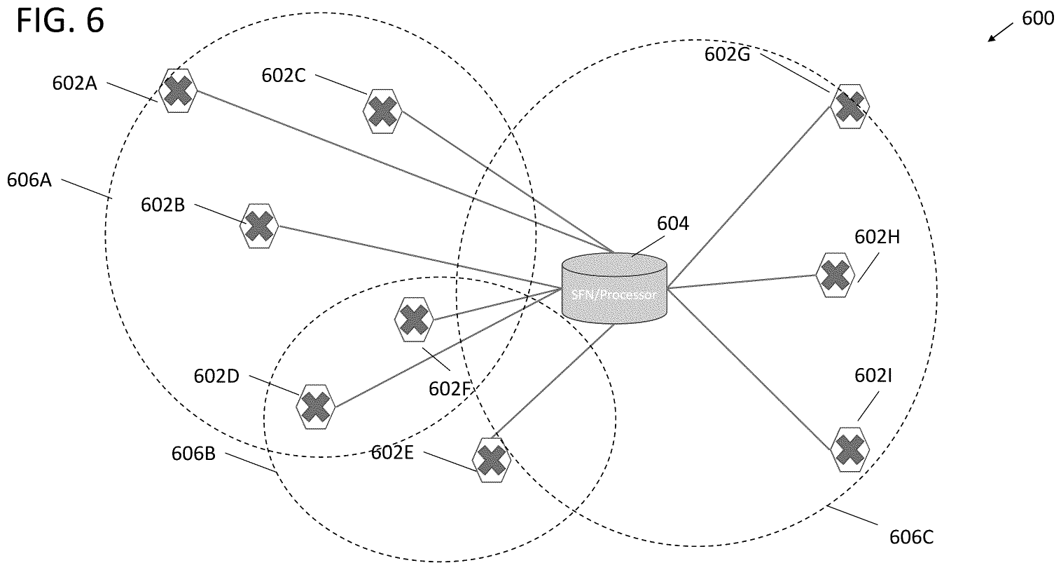

FIG. 6 illustrates an exemplary multistatic and multifrequency radar network implemented with monostatic radar nodes and centrally controlled by a Single Frequency Network Adapter according to examples of the disclosure. In one or more examples, the system 600 of FIG. 6 can operate in a substantially similar manner to the system 300 described above with respect to FIG. 3. Thus, in one or more examples, the system 600 of FIG. 6 can include a plurality of radar nodes 602A-I. In one or more examples, the radar nodes 602A-I can be grouped into “frequency zones” 606A-C. In one or more examples, radar nodes 602A-C can be a part of frequency zone 606A and emit a signal at a first carrier frequency. Radar nodes 602D-F can be part of frequency zone 606B and emit a signal at a second carrier frequency. Radar nodes 602G-I can be part of the frequency zone 606C and emit a signal at a third carrier frequency. In one or more examples, the first, second, and third carrier frequency can be distinct from one another and spaced far enough apart to avoid interfering with one another during operation of the system 600. In one or more examples, the first, second, and third frequencies can be selected within the range of 400 MHz-5 GHz as an example. In one or more examples, the bandwidth of a transmit signal (i.e., a signal emitted by the transmitters of the radar nodes 602A-I) can be 50 KHz nominally but can operate using a bandwidth of 50 KHz-125 KHz. This “narrowband” signal can stand in contrast to conventional systems or passive radar systems that use 200 KHz bandwidth signals such as those used in FM radio broadcasts. In one or more examples, the radar system can use a mix of “narrowband” and “wideband” signals to illuminate targets of interest for the purpose of determining an object's location, elevation, velocity, and/or track.

In one or more examples, SFN adapter/processor 604 (which can operate in substantially the same manner as the SFN adapters/processors described above with respect to FIGS. 4-5) can be communicatively coupled to each of the transmitters of the radar nodes 602A-J and can cause them to transmit the same signal at the same time as described above (using a plurality of different carrier frequencies). However, in contrast to the examples provided above, rather than transmit each of the signals at the same frequency, each transmitter can transmit the signal that is modulated to a carrier frequency that is associated with the frequency zone that the transmitter is in. For instance, while the transmitters of nodes 602A-I can all transmit the same signal at the same time, the transmitters associated with frequency zone 606A can modulate the signal using a first carrier frequency, the transmitters associated with frequency zone 606B can modulate the signal using a second carrier frequency, and the transmitters associated with frequency zone 606C can modulate the signal using a third carrier frequency. Additionally or alternatively, each signal can also be modulated using one or more known modulation schemes such as analog modulation (amplitude modulation, frequency modulation, phase modulation, etc.,) digital modulation (ASK, FSK, etc,), and spread spectrum modulation.

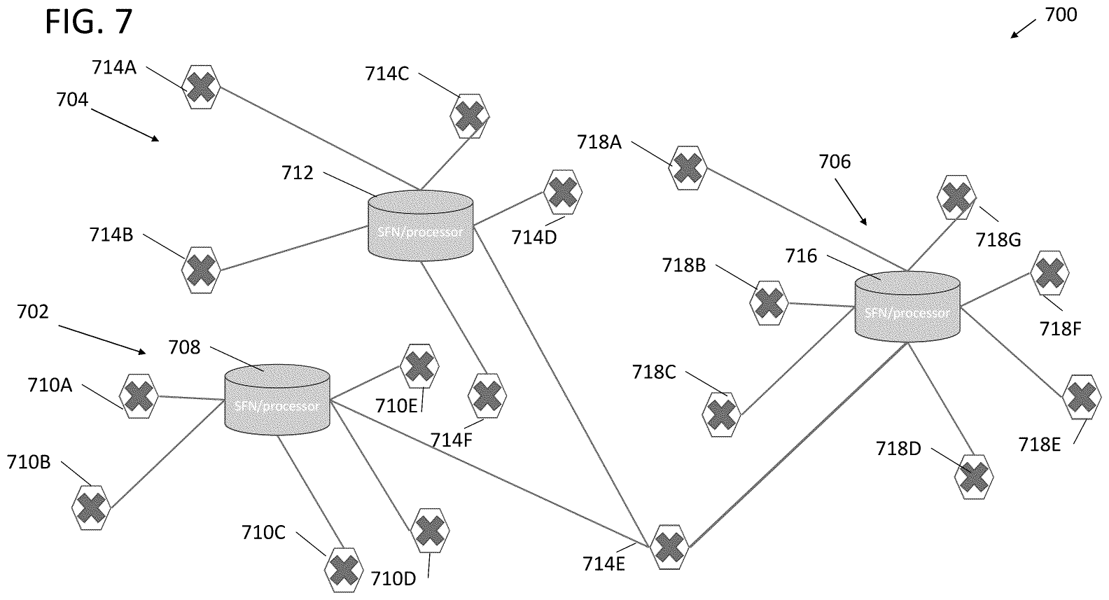

In one or more examples a multistatic radar network can be composed of multiple multistatic static radar systems that are each controlled by a separate single frequency network adapters. For instance, in one or more examples, a multistatic radar network can include a dedicated single frequency network that operates one or more transmitters, with each transmitter broadcasting its own pre-determined carrier frequency and modulation scheme as coordinated by the SFN adapter. The multistatic radar network can also include a paging network that has been co-opted to operate as both a paging network and a multistatic radar network, and the multistatic radar network (FIG. 7) can include a dedicated reference network to provide one or more reference signals (described above) to further improve the accuracy of the radar network.

FIG. 7 illustrates an exemplary multistatic radar network composed of multiple single frequency networks according examples of the disclosure. In one or more examples, the radar network 700 can be composed of multiple single frequency networks 702, 704, and 706 that can collectively implement the multistatic radar network. In one or more examples, single frequency network 702 can operate similar to the examples described above with respect to FIGS. 4-6, wherein the single frequency network adapter 708 can transmit a common signal to transmitters 710A-E. In one or more examples, each transmitter 710A-E can be configured to transmit the signal received from the SFN Adapter/processor 708 at a specific carrier frequency and modulation signal. The SFN Adapter/processor 708 can work to ensure that each transmitter 710A-E transmits its signal synchronously (i.e., at substantially the same time) thereby improving the overall accuracy of the radar network 700.

In some embodiments, the radar networks described herein can be implemented as stand-alone radar network that use a plurality of transmitters and receivers that are specifically designed to perform position, navigation, and timing functionality. Additionally and/or alternatively, in one or more examples, the multistatic radar network 700 can also include a paging network 704 that can be operated as both a paging network and a multistatic radar network according to the examples described above. In one or more examples, the paging network 704 can be operated with its own SFN Adapter/processor 712 that can transmit a common signal to each of the transmitters 714A-F such that each transmitter transmits its signal synchronously. In one or more examples SFN Adapter/processor 712 and SFN Adapter/processor 708 of single frequency network 702 can be communicatively coupled to one another to ensure that both networks 702 and 704 transmit their signals synchronously.

In one or more examples, the multistatic radar network 700 can also include a reference signal network 706 that can be configured to transmit one or more reference signals as described above. In one or more examples, the reference signal network 706 can be operated by its own SFN Adapter/processor 716 that transmits a common signal to each of the transmitters 718A-G, such that each transmitter transmits synchronously. In one or more examples, the SFN Adapter/processor 716 can be communicatively coupled to each of the other SFN adapters in the network (i.e., SFN adapters 708 and 712) such that all the transmitters of the network transmit a signal synchronously with all of the other transmitters in the network. In this way, the overall network 700 can transmit signals using different signals (that are controlled by each of the SFN adapters/processors) that are modulated according to various modulation schemes and at various carrier frequencies, thereby providing the multistatic radar network with signal diversity that can improve the overall accuracy of multistatic radar network.

In one or more examples, one or more of the SFN adapters/processors can be common to a radar node and/or transmitter. For instance, as illustrated in FIG. 7, each of SFN adapters/processors 708, 712, and 716 can be communicatively coupled to a common radar node 714E, and more specifically to the transmitter associated with radar node 714E. In one or more examples, the transmitter at radar node 714E can be configured to transmit signals corresponding to the one or more frequencies and/or modulation schemes associated with the radar network 700, paging network 704, and reference signal 706. Optionally, a single transmitter site of a radar node includes a plurality of transmitters, with each transmitter communicatively coupled to its own SFN adapter. Additionally or alternatively, one or more SFN adapters/processors can be communicatively coupled to a common transmitter, and the transmitter can time multiplex the SFN adapters/processors to transmit signals received according to each SFN adapter/processor. The multiple SFN signals, each on a separate channel, can be interspersed with other commercial transmissions, such as paging, two-way radio or other broadcast services occupying separate licensed channels. The transmitter can optionally time multiplex the plurality of signals received from the SFN adapters/processors 708, 712, 716, so as to illuminate a target from various positions. For example, a spread spectrum signal, such as a chirp, whose bandwidth is greater than a single channel can be decomposed into several contiguous frequency channels. Each channel can be transmitted (in order) sequentially through a single transmitter. Additionally or alternatively, each channel can be transmitted by multiple transmitters in a round-robin fashion. For example, at a first instance of time, a first transmitter (TXA) transmits a first chirp signal (Chirp1), a second transmitter (TXB) transmits a second chirp signal (Chirp2) and a third transmitter (TXC) transmits a third chirp signal (Chirp3). In the next instance, TXA transmits Chirp2, TXB transmits Chirp3 and TXC transmits Chirp1 and so forth. Additionally or alternatively, TXA may transmit the signal as (low to high channel) Chirp1, Chirp2 and Chirp3 together, while TXB transmits Chirp2, Chirp3 and Chirp1. This will allow blanking of same-site receivers at appropriate times and avoids interference associated with transmitting all of the signals simultaneously. In this way, multiple SFN adapters can utilize a common radar node, thereby reducing the overall footprint of the multistatic radar network.

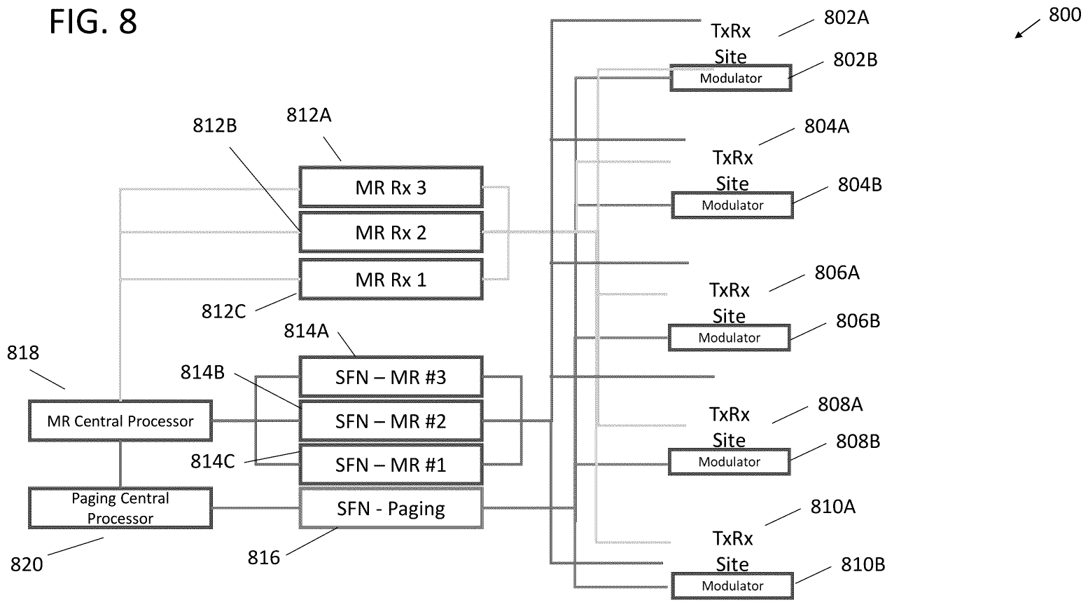

In one or more examples, a multistatic radar network composed of multiple multistatic radar systems each controlled by its own separate SFN adapter can be administered in a coordinated manner such that the network can collectively operate to accurately detect and track airborne object in a given air space. FIG. 8 illustrates an exemplary control system for a multistatic radar network according to examples of the disclosure. In one or more examples, the system 800 of FIG. 8 can be used to coordinate the operations of multiple single frequency networks to administer and operate a multistatic network like the network described above with respect to FIG. 7. In one or more example, the system 800 can include a plurality of radar nodes 802A, 804A, 806A, 808A, and 810A, each node includes both a transmitter and a receiver according to the examples described above with respect to FIGS. 1-7. Each transmitter 802A, 804A, 806A, 808A, and 810A, can include its own respective modulator 802B, 804B, 806B, 808B, and 810B. In one or more examples, each radar node 802A, 804A, 806A, 808A, and 810A can be communicative coupled to one or more multistatic radar (MR) receivers 812A-812C. The MR receivers 812A-C can be configured to receive signals from each of the receivers associated with a radar node and process them for later use in the detection and tracking of airborne objects. For instance, in one or more examples, each the MR receivers 812A-812C can process their received signals, and transmit them to an MR central processor 818 that can be configured to “fuse” the received signals together (as discussed above) in order to perform detecting and tracking.

In one or more examples, the system 800 can include a plurality of single frequency network adapters 814A-C as well as 816. In one or more examples, SFN adapters 814A-C can each be communicatively coupled to one or more transmitters of the network associated with the radar network as illustrated in FIG. 8. In one or more examples, and as described in detail above, each of the SFN adapters can be used to administer synchronization amongst its own multistatic radar system and the plurality of multistatic radar systems can collectively be configured to implement a multistatic radar network that provides detection and tracking of airborne objects in a given coverage area. In one or more examples, each of the SFN adapters/processors 814A-C can be communicatively coupled to the MR central processor 818 which can coordinate the transmission of signals for broadcasting by the transmitters such that the transmitters emit a signal synchronously as described in detail above.

In one or more examples, the system 800 can also include a paging network similar to the examples described above. For instance, the system 800 can include a SFN adapter 816 that is configured to operate the paging network as both a paging network and as generate signals used for multistatic radar detection when the paging network is idle. In one or more examples, the paging SFN adapter 816 can be communicatively coupled to a paging central processor 820 that can coordinate the operations of the paging SFN adapter 816 such that the adapter can operate the transmitter function (by ensuring that the signals transmitted at each transmitter are time synchronized) as part of a paging network, and as part of a multistatic radar network. In one or more examples, the paging central processor 820 can be communicatively coupled to the MR central processor 818 in order to ensure that each of the transmitters in the network emit a signal synchronously thereby improving the performance of the overall multistatic radar network as described in detail above. In the example of system 800 of FIG. 8, each of the multistatic radar systems are illustrated as being communicatively coupled to the same transmitters, but in one or more examples, and as described above, one or more of the multistatic radar systems can include their own dedicated transmitters, or can share transmitters as shown with respect to FIG. 8.

In some embodiments, the density of the networks described above with respect to FIGS. 1-8 can be predefined so as to provide the needed resolution for the system, while also taking into account the cost of implementing the system. In one or more examples, the number of transmitters and/or receivers (e.g., nodes) are greater than what would otherwise be needed for a stand-alone communications network in order to provide the resolution required. In some examples, and as described above, the density of the network can vary across the coverage area of the network in order to account for RF conditions at various points within the coverage area. For instance, the denser network can be implemented in urban areas, while the network can be less dense in rural or otherwise less RF congested airspace. In one or more examples, the density of the network can be leveraged to overcome transmit power and bandwidth deficiencies that would otherwise serve as impediments to accurate detection, location, and tracking of airborne objects.

In some embodiments, the radar networks described above with respect to FIGS. 1-8 can also perform timing operations (e.g., acquire and maintain accurate timing information for the radar network itself) that can be used for data fusion operations to determine position information about airborne objects that have been detected in the coverage area of the radar network.

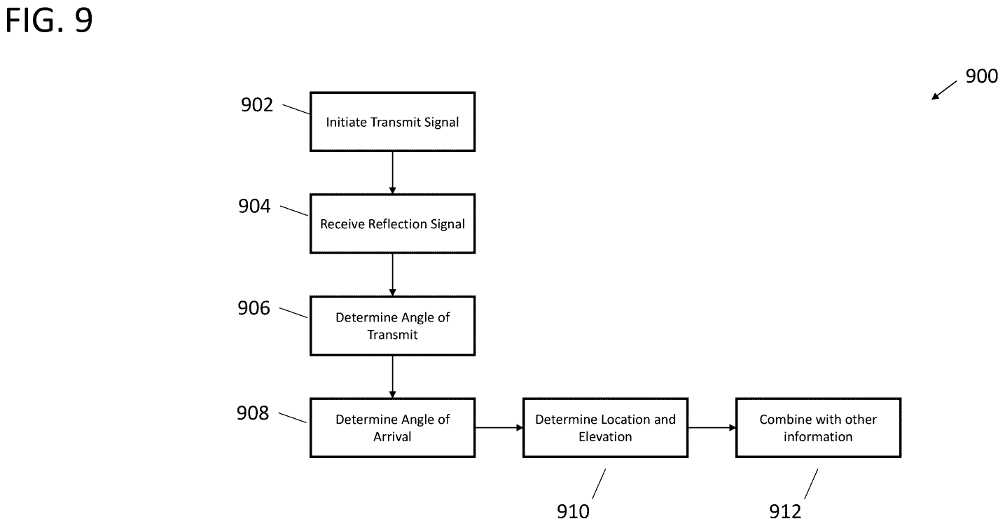

FIG. 9 illustrates an exemplary process for operating a multistatic radar network to detect airborne objects according to examples of the disclosure. In one or more examples, the process 900 of FIG. 9 can be an exemplary process for operating the radar networks described above with respect to FIGS. 1-8. In one or more examples, the process 900 can begin at step 902 wherein one or more processors that can be located at an individual transmitter of a radar node or at a central location, can initiate a transmit signal to be transmitted so as to illuminate a given coverage area. FIG. 9 displays the process for a single TX/RX pair and is easily expanded to multiple TX/RX pairs. In one or more examples, and as discussed above, the individual transmitters of the radar nodes can be caused to transmit a signal based on a shared clock (synchronized by a GPS signal). Additionally or alternative, the transmitters can be caused to transmit a signal synchronously by a SFN adapter as described above with respect to FIGS. 4-6.

In one or more examples, at step 904, the one or more processors of the system can receive a plurality of received (reflections) signals from the one or more radar nodes of the system. In one or more examples, and as described above, the reflections signals can be received at each of the individual receivers associated with each radar node, and those signals can then be transmitted to a common processor that knows the transmitter locations, receives the reflection signals from each of the receivers in the network and “fuses” them together (aggregates them) to determine the location and track of objects in the coverage area of the radar network (as described above).

In one or more examples, upon receiving the reflection signals from the plurality of radar nodes, the process can determine the angle of transmit associated with each received reflection wave and the angle of reflection associated with each received reflection signal at steps 906 and 908 respectively. Once the angle of transmit and the angle of reflections have been determined at steps 906 and 908 respectively, the process 900 can move to steps 910 wherein the determined angles are used to determine the location, elevation, speed, and/or track of objects in the coverage area of the radar network.

In one or more examples, the location, elevation, speed, and/or track of an airborne object can be determined by performing triangulation and/or multilateration the data provided by the individual radar nodes as described above. In one or more examples, a single bistatic communications link (e.g., transmitter and receiver pair) can be used to perform detection of an airborne object. In some examples, “detection” of an airborne object refers to determining the presence of an airborne object in a coverage area of a radar network without necessarily determining the precise location/elevation of the airborne object. In some examples, detection is performed with a single bistatic link with only minimal fusion of data from other sources (e.g., other bistatic and/or monostatic links) to determine that an airborne object is present in the coverage area of the radar network.

In some embodiments, in order to determine the location of an aircraft (e.g., the precise latitude and longitude) of the aircraft, the radar network can fuse data from multiple bistatic and/or monostatic links that are part of the radar network to determine the location of an airborne object through triangulation and multilateration. For instance, in order determine the two-dimensional location of an airborne object that has been detected using the process described above, the radar network can utilize at least three different bistatic and/or monostatic links of the radar network to triangulate the two-dimensional location of the airborne object. In one or more examples, and using radar network 300 of FIG. 3 as an example, processor 304 can receive signals from receivers and transmitters at nodes 302A, 302E, and 302J (as examples), fuse the data together (e.g., integrate the multiple data sources to produce a determination of position that would not otherwise be possible with a single data source), so as to estimate the position of the airborne object.

In one or more examples, and as part of the determinations made at step 910, the radar system (through the use of one or more processors) can determine the elevation of the airborne object (e.g., the altitude of the aircraft). For instance, in one or more examples, each receiver in the radar network can be equipped with two separate receive antennas that are spaced one wavelength part (e.g., based on the carrier frequency of the transmitted signal) to determine the elevation angle of the received signal relative to the horizon. In some embodiments, the antenna separation is based on the polarization of the signal and can be separated vertically by one wavelength and/or separated horizontally by one wavelength. By determining the elevation angle, and by also having knowledge of the aircraft range, the system can determine the altitude of the airborne object as part of the process of determining the location of the aircraft at step 910 of method 900.

In one or more examples, and as part of determinations about the airborne object made at step 910, the system can also track an airborne object (e.g., determine the movement trajectory of the aircraft over time) by fusing multiple sources of data from the radar network (e.g., data acquired from various transmitter/receivers in the network) to track the aircraft's movement over the coverage area of the network.

In one or more examples, the determinations made at step 910 can be combined with other sources of information that can be used to corroborate (and/or train AI/ML systems as described above) the determinations at step 912. For instance, in one or more examples, if an aircraft being tracked broadcasts Automatic Dependent Surveillance-Broadcast (ADS-B), information provided by airborne radios which are configured to report position, altitude, and/or velocity, or Remote ID (RID) signals, then those signals can be used to corroborate the findings of the radar network and can validate the results provided by the radar network and help to improve the overall resolution of the radar network. Additional and/or alternatively In one or more examples, ADS-B or Remote ID signals can be used in conjunction with other training data to train a Artificial Intelligence and/or Machine Learning classifier that can be utilized to perform sensor fusion and/or improve the accuracy of sensor fusion operations with the ADS-B signal acting as a source of truth for the training data.

In one or more examples, the target location and trajectory information collected by the radar system can be combined with other information sources such as ADS-B or other types of information or communications relayed by participating aircraft to improve recognition of objects and improve resolution of target location and trajectory information. In one or more examples, the transmitters of the multistatic radar network can be configured to operate as a single frequency network (i.e., a paging or pulsing type service) in which each transmitter is centrally controlled and configured to synchronously transmit a “pulsed” signal or a “page” that can be used by the receivers in the multistatic network to discern location information for any airborne vehicles transiting the coverage area of the radar network.

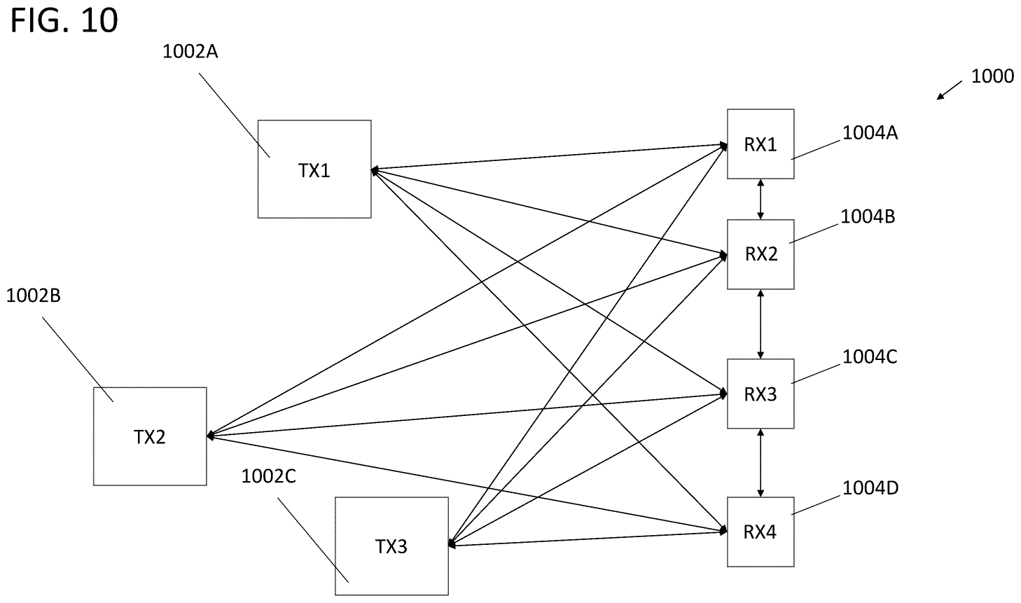

In some embodiments, rather than employing a single frequency network adapter and/or an external clock such as GPS, the multistatic radar network can include a stand-alone timing system that can be used to synchronize transmissions in the multistatic radar network. FIG. 10 illustrates an exemplary dedicated timing network for a multistatic radar network according to example of the disclosure. In the example system of FIG. 10, rather than employing a GPS signal and/or a single frequency network adapter to synchronize the timing of the transmitters, the system 1000 can be employed to synchronize the clocks of the transmitters to transmit signals either at the same time, same frequency, and/or different modulation schemes.

In the example of the system 1000 of FIG. 10, each transmitter of the multistatic network includes a timing processor 1002A-C respectively, that transmits a timing signal to one or more timing processors 10004A-D associated respectively with a receiver of the multistatic radar network. In some examples, to accurately measure target range (e.g., the distance between the receiver and an airborne object), each receiver needs an accurate sense of the time-of-flight of each transmitter's pulse. In order to achieve this, the timing processors 1002A-C associated with the transmitters and the timing processors 1004A-D, perform a two-way time transfer and ranging (TWTTR) process for each transmitter/receiver pair. Thus, in the example of the timing processor 1002A associated with a first transmitter of the multistatic radar network, the timing processor will perform a TWTTR process with each timing processor associated with a receiver 1004A-D (e.g., processor 1002A performs four TWTTR processes, one for each receiver in the network).

In one or more examples, the TWTTR process is performed by each timing processor directly transmitting a timing signal to the processors that are being synchronized (using a wired and/or wireless communication link) to determine time of fight information that can then be used to synchronize the clocks of each transmitter and receiver. In some examples, each timing processor at the receiver can obtain relative time/frequency by processing the direct path signals from the timing processors 1002A-C located at each transmitter. In some examples, the receiver does not need absolute knowledge of time/frequency, but rather just needs to be able to measure time relative to the transmitter using the direct path signals that are transmitted from the timing processors associated with each transmitter. In some examples, each timing processor 1004A-D associated with each receiver can use the time-of-flight information to adjust the internal clock of the receiver it is associated with so that all the nodes of the multistatic radar network are synchronized.

In one or more examples, the timing system illustrated in FIG. 10 can be used an alternative to the GPS signals and/or single frequency network adapters to synchronize the receivers and transmitters of the multistatic radar network.

According to one or more examples of the disclosure, a system for detecting and tracking airborne objects, the system comprises: a plurality of radar nodes, wherein each radar node of the plurality of radar nodes comprises at least a transmitter and a receiver (which may or may not be geographically co-located with one another), a memory, and one or more processors, wherein each processor of the one or more processors is communicatively coupled to each radar node of the plurality of radar nodes, wherein the memory stores one or more programs that when executed by the one or more processors, cause the one or more processors to: transmit one or more control signals to each transmitter of each radar node of the plurality radar nodes, wherein each transmitter, in response to receiving the one or more control signals from the one or more processors is configured to transmit one or more pre-determined signals at one or more pre-determined carrier frequencies using one or more pre-determined modulation schemes, operate each transmitter of each radar node of the plurality of radar nodes to simultaneously transmit a signal, wherein the signal transmitted at each transmitter is based on the one or more pre-determined carrier frequencies and the one or more pre-determined modulation schemes associated with the transmitter, receive from the one or more receivers of plurality of radar nodes one or more reflection signals, wherein the one or more reflection signals comprise transmit signals that have reflected off one or more airborne objects, and determine a position and/or range of the one or more airborne objects based on the received one or more reflection signals.

Optionally, one or more radar nodes of the plurality of radar nodes is implemented as a monostatic radar node.

Optionally, wherein one or more radar nodes of the plurality of radar nodes is implemented as a bistatic radar node.

Optionally, a transmitter and receiver of a bistatic radar node are geographically separated from one another.

Optionally, the plurality of radar nodes are geographically separated from one another.

Optionally, the one or more processors operate each transmitter of the plurality of radar nodes as a single frequency network.

Optionally, the transmitters of each radar node of the plurality of radar nodes collectively comprise a paging network.

Optionally, the one or more processors operate a first set of the transmitters of the plurality of radar nodes to transmit a signal at a first frequency, and wherein the one or more processors operate a second set of the transmitter of the plurality of radar nodes to transmit a signal at a second frequency.

Optionally, the first frequency and second frequency are based on a pre-determined. resolution of the radar system

Optionally, determining a position of the one or more airborne objects based on the received one or more reflection signals comprises determining a location and elevation of the one or more airborne objects.

Optionally, determining a position of the one or more airborne objects comprises determining a velocity of the airborne object.

Optionally, determining a position of the one or more airborne objects comprises determining a direction of travel of the airborne object.

Optionally, determining a presence of the one or more airborne objects based on the received one or more reflection signals and the fusion of multiple received signals comprises determining a track of each airborne object of the one or more airborne objects.

Optionally, operating the transmitter of each radar node comprises setting a transmit power for each transmitter of each radar node.

Optionally, each radar node of the plurality of radar nodes is synchronized using one or more timing synchronization methods (eg global positioning system (GPS) signals, network timing source, single frequency network adapter, rubidium clocks, etc.)

Optionally, determining a position of the one more airborne objects based on the received one or more reflection signals comprises determining an angle of transmit and an angle of reflection for each received reflection signal.

Optionally, determining a position of the one or more airborne objects based on the received one or more reflection signals comprises combining the determined angle of transmit and the determined angle of reflection for each received reflection signal with an Automatic Dependent Surveillance-Broadcast (ADS-B) signal emitted by the one or more airborne objects to determine the position of the one or more airborne objects.

Optionally, the pre-determined modulation scheme comprises an analog modulation scheme.

Optionally, the pre-determined modulation scheme comprises a digital modulation scheme.

Optionally, the one or more processors are caused to operate each transmitter of the plurality of radar nodes as a paging network.

Optionally, the pre-determined carrier frequency and the pre-determined modulation scheme are configured to operate the system as a paging network.

Optionally, the one or more processors are caused to operate each transmitter of the plurality radar nodes to generate a reference signal for a multistatic radar network.

Optionally, the one or more transmitters are caused to emit one or more narrow-band signals, and wherein the one or more narrow-band signals emitted by the one or more transmitters are collectively configured to emulate a single wide-band RF signal.

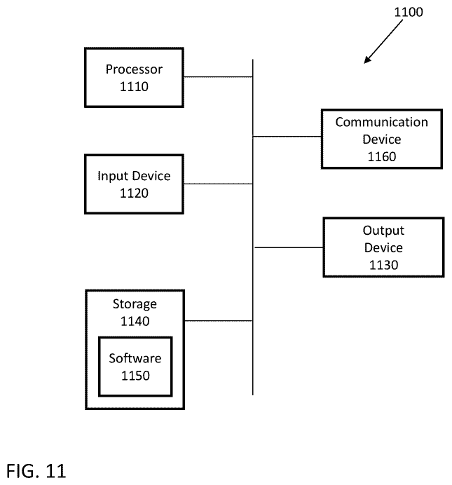

FIG. 11 illustrates an exemplary computing system, according to examples of the disclosure. FIG. 11 illustrates an example of a computing system 1100, in accordance with some embodiments system 1100 can be a client or a server. As shown in FIG. 11, system 1100 can be any suitable type of processor-based system, such as a personal computer, workstation, server, handheld computing device (portable electronic device) such as a phone or tablet, or dedicated device. The system 1100 can include, for example, one or more of input device 1120, output device 1130, one or more processors 1110, storage 1140, and communication device 1160. Input device 1120 and output device 1130 can generally correspond to those described above and can either be connectable or integrated with the computer.

Input device 1120 can be any suitable device that provides input, such as a touch screen, keyboard or keypad, mouse, gesture recognition component of a virtual/augmented reality system, or voice-recognition device. Output device 1130 can be or include any suitable device that provides output, such as a display, touch screen, haptics device, virtual/augmented reality display, or speaker.

Storage 1140 can be any suitable device that provides storage, such as an electrical, magnetic, or optical memory including an SSD, a RAM, cache, hard drive, removable storage disk, USB stick, or other non-transitory computer readable medium. Communication device 1160 can include any suitable device capable of transmitting and receiving signals over a network, such as a network interface chip or device. The components of the computing system 1100 can be connected in any suitable manner, such as via a physical bus or wirelessly.

Processor(s) 1110 can be any suitable processor or combination of processors, including any of, or any combination of, a central processing unit (CPU), field programmable gate array (FPGA), and application-specific integrated circuit (ASIC). Software 1150, which can be stored in storage 1140 and executed by one or more processors 1110, can include, for example, the programming that embodies the functionality or portions of the functionality of the present disclosure (e.g., as embodied in the devices as described above)

Software 1150 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by or in connection with an instruction execution system, apparatus, or device.

Software 1150 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 1100 can implement any operating system suitable for operating on the network. Software 1150 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application arc hereby incorporated herein by reference.

1. A system for detecting and tracking airborne objects, the system comprising:
a plurality of transmitters, wherein each transmitter of the plurality of transmitters is operated to transmit a deterministic signal;
a plurality of receivers, wherein each receiver of the plurality of receivers is configured to receive reflective signals transmitted at least one transmitter of the plurality of transmitters;
a memory; and
one or more processors, wherein each processor of the one or more processors is communicatively coupled to each transmitter of the plurality of transmitters, and coupled to each receiver of the plurality of receivers;
wherein the memory stores one or more programs that when executed by the one or more processors, cause the one or more processors to:
receive a plurality of reflection signals received at each receiver of the plurality of receivers;
fuse the plurality of reflection signals;
detect an airborne object based on the fused plurality of reflected signals;
determine a position of the airborne object based on the fused plurality of reflected signals; and
track the airborne object based on the fused plurality of reflected signals.
